(19) United States
(12) Patent Application Publication
(10) Pub. No.: US 2007/0155477 A1
(43) Pub. Date: Jul. 5, 2007

(54) Gaming system incorporating a karaoke feature

(76) Inventor: Justine Gevisser, London (GB)

Correspondence Address: MCDONNELL BOEHNEN HULBERT & BERGHOFF LLP, 300 S. WACKER DRIVE, 32ND FLOOR, CHICAGO, IL, 60606, US

(21) Appl. No.: 11/639,601

(22) Filed: Dec. 15, 2006

(30) Foreign Application Priority Data
Dec. 23, 2005 (GB) 0526268.8

(51) Int. Cl. A63F 13/00

(52) U.S. Cl. 463/20

(57) ABSTRACT

A gaming system includes a gaming machine for playing a game of chance and a karaoke machine, which are contained within a single housing. Each machine is operable to permit a user of the machine to achieve any one of a number of possible outcomes on the machine. The machines co-operate so that achievement of a predetermined one of the possible outcomes on one of the machines enables the user to access the other machine and to participate thereon. Either or both the gaming machine and the karaoke machine are connected to a content server capable of providing different game or karaoke content for the machines.

### FIELD OF THE INVENTION

This invention relates to gaming. The invention also relates to karaoke. In particular, the invention relates to a gaming system incorporating a karaoke feature and to a method of operation of such a gaming system.

### BACKGROUND TO THE INVENTION

Many varieties of gaming are known and gaming is growing in popularity. Gaming takes many forms and is implemented on a wide variety of systems and machines including slot machines, progressive jackpot machines, fruit machines, pachinko machines, mobile gaming systems, table games such as poker, blackjack and roulette, bingo games and the like. Further, these gaming facilities may be land-based, being provided in casinos, gaming arcades, pubs and the like, or may be virtual gaming systems, which are generally accessed via the internet. It is also becoming increasingly common to provide a secondary, or bonus game, linked to the primary game played on one of these gaming systems. So, for example, a participant who wins or fulfills a predetermined criterion on a primary game played on a gaming system may thereby be entitled access to a bonus feature, or secondary game. The additional features and elements add to the attraction of the gaming system and offer a player of the game an opportunity to win both in the primary and secondary, or bonus game.

Further, karaoke has also become increasingly popular throughout the world. Karaoke is a facility which generally provides backing music and, optionally, information, such as the lyrics of a song, to enable a participant to sing along to the music, generally by means of a microphone. Further features may be added to the karaoke system, including visual effects and a function that determines, according to preselected criteria, the performance levels of the participants. So, for example, the participant may be evaluated on volume levels, tonal accuracy, the correctness of lyrics and the like.

It would be an advantage to combine the features of gaming systems and karaoke systems to capitalize on the popularity and attraction of both facilities. It would also be an advantage to utilize the karaoke feature as a component of a secondary gaming system to provide a bonus feature to the game played on a primary gaming system. Still further, it would be an advantage to provide a gaming system which includes linked gaming devices, a first of which being a gaming machine and a second of which being a karaoke machine, the devices being co-operable by a user of the system. Yet further, it would be an advantage to provide a gaming system operable to allow the simultaneous participation in a slots game and in a karaoke facility.

### OBJECT OF THE INVENTION

It is an object of the invention to provide a novel gaming system which includes co-operable devices, a first of which being a gaming device and a second of which being a karaoke device. It is a further object of the invention to provide a method of operating such a gaming system. It is a still further object of the invention to provide a gaming system and method for operating a gaming system which will achieve, at least in part, the advantages set out above.

### SUMMARY OF THE INVENTION

According to a first aspect of the invention there is provided gaming system including
a pair of interactive devices, a first of which being a gaming machine for playing a game of chance and a second of which being a karaoke machine,
at least one of the devices being operable to permit a user of the device to achieve a plurality of outcomes on a turn at the device and the devices being co-operable so that the achievement of a predetermined outcome on the said at least one device enables the user to access the other of the devices and to participate thereon.
According to a second aspect of the invention there is provided a method for operating a gaming system which includes a pair of interactive devices, a first of which being a gaming machine for playing a game of chance and a second of which being a karaoke machine, the method including
enabling a user of the system to access one of the devices to play a turn of the said device, the device being operable to provide a plurality of outcomes on a turn of the device; and
on the achievement of a predetermined outcome on the said device, enabling the user access to the other of the devices to participate thereon.

The plurality of outcomes on the one of the devices may include at least one successful outcome and one or more unsuccessful outcomes. There may be a plurality of successful outcomes of varying degrees of success. Each successful outcome may entitle the user to an award. The value or size of the awards may be related to the degree of success of the outcome.

Access to the other of the devices may in itself comprise an award for a successful outcome. Instead, the other of the devices may be operable to provide a plurality of outcomes on a turn of the device. Again, in respect of the other of the devices, there may be a plurality of successful outcomes of varying degrees of success. Each successful outcome may entitle the user to an award. The value or size of the awards may be related to the degree of success of the outcome.

The first gaming device may be of the Skill With Prizes (SWP's) type, Amusement With Prizes (AWP's) type, Arcade type, Pachinko Machines or the like. Further, the gaming device may be provided in the games mix of a land-based venue, online gaming site or through mobile technology.

Some examples of embodiments of the first gaming device include the following:
1. video slots machines;
2. mechanical reel slot machines;
3. progressive jackpot machines;
4. fruit machines;
5. Pachinko machines;
6. mobile gaming devices;
7. table games, such as video poker, video roulette and the like; and
8. bingo games.

The gaming system may be implemented on a land-based gaming machine or system of linked machines or on an online gaming system accessed via an internet enabled home PC or other access device. Additional hardware requirements for the systems include some or all of the following, which are linked to the land-based gaming machine or access device for the online gaming system: Speakers (if not already provided) and an amplification system and/or soundcard may be required. Preferably, these are of a sufficiently good quality so that the singer/player is audible in the environment of the gaming machine. A microphone is also required so that the singer's voice may be amplified and broadcast. This also allows for a sound input for evaluation and enables the input to be measured against predetermined criteria to establish a successful of unsuccessful outcome of a further, sound-based game played on the karaoke device. In some circumstances, such as where the ambient noise level is high, a set of headphones may be provided. These also serve to maintain a level of privacy. Various external sound sensors may also be provided. So, for example, a so-called “clappometer” or “noiseometor” may measure the appreciation of an audience to the karaoke performance of the player of the system, where the system is located in a public space. The readings of these sensors may provide a further means for evaluation and determination of a successful or unsuccessful outcome of the karaoke leg of the bonus game. On certain gaming machines, in land-based venues such as casinos, it will be beneficial to have a second screen running the karaoke part of the game. Further, video and graphics cards may be incorporated in the gaming machine or access device to ensure music and graphical elements are displayed correctly. It is also envisaged that a large display screen may be provided in land-based venues. Such a screen, which may be an LCD screen, may be located in front of a bank of gaming machines to allow players to win the right to sing off the big screen, thereby providing a spectacle and show and encouraging more participants in the game.

In essence, the right to access the karaoke element of the system may, in itself, be considered a bonus reward. However, further, more tangible rewards may be provided. Thus, the karaoke device may be software driven and may be operable to evaluate input from a player of the system and to determine a successful or unsuccessful result, in relation to any one or more of a number parameters, including:
1. tone or pitch of the singer;
2. pace of the singer;
3. style;
4. intonation or pronunciation;
5. word count of lyrics;
6. correctness of the lyrics.
7. musicality;
8. effort.

Instead, the outcome of the performance on the karaoke machine may be randomly determined.

Thus the sound processing software may be relatively simple, determining outcome as a function only of amplitude, for example. Instead, the software functionality may be relatively complex, for example combining correctness of pitch and timing with a measure of the number of words of the lyrics of a song correctly sung by a player. Existing software, such as incorporated in the system known under the trade name “BetStone” already provides a basis for such a software driven system and includes interfacing IO interactivity, processing power and Windows interfacing.

Thus, in one preferred embodiment of the invention a typical slots video gaming machine is linked to a karaoke facility. In use, if a slots player wins on a turn of the primary slots game, instead of being taken to a bonus screen where he/she is required to gamble, or play/interact with a bonus game in order possibly to realize a larger win (as is commonly the case), he/she is given the opportunity to sing on the karaoke machine. The lines of the song are then displayed on the video screen of the slots machine. Accompanying music is played through a set of speakers and the player sings into an attached microphone. The outcome of a secondary, bonus game depends on the vocal performance of the player in respect of preselected parameters related to this performance. These parameters may include any or some or all of the following: tone, pace, style, intonation, pronunciation, word count, word correctness, musicality, and/or effort. Instead, the outcome may be randomly determined and the reward to the player would be in being offered the opportunity to participate in the karaoke bonus module of the game. It will be appreciated that this embodiment of the invention may have application in the context of a slots game in which actual rewards are provided on a successful outcome of a primary slots game. However, the embodiment also has application in a play-for-fun environment, where a successful outcome on a turn of the slots game merely permits a player access to the karaoke facility without any other form of award.

Added features, such as the display of video footage of an actual artist singing (a music video with words of the song being played) may be included, as may the use of a large screen visible from a bank of slots machines. A further random element may be introduced by grading the songs of the karaoke machine on a scale of relative difficulty or obscurity and randomly selecting a song on the occurrence of a winning event on the primary slots machine.

Still further, the games of the gaming machine and the songs of the karaoke may be selected to follow a particular theme.

In further embodiment of the gaming system, the system operates generally as described above with respect to the previous preferred embodiment. However, a further element of chance is introduced in that a random weighting is attached to the parameters in respect of which performance at karaoke is assessed. Thus, for example, a player may be musical and may score highly on the scale of correctness of lyrics and singing in harmony, but these parameters may be given a low weighting, whereas a player who scores low in these parameters may be rewarded for scoring high on the effort scale. The weighting of parameters may be predetermined and may be selectively altered from time to time, or may be randomly determined and altered from time to time. The variability will add to both the ‘fun’ and the ‘luck’ of the game, and will also prevent teams of players from trying to ‘work the game’ (i.e. one player places the money and spins, the other sings).

The system may be operable to permit a player to achieve monetary or other bonus awards, such as game credits on either the primary game or the karaoke game. Further, the system may be operable to enable a player to bank awards and to redeem them at his or her option. In one embodiment, the awards may accumulate to the stage where they comprise the right to sing an entire song, rather than only a few lines. The system may also be set up to permit the loss of accumulated bonus awards.

In a further preferred embodiment of the invention, the relationship between the gaming device and the karaoke device is reversed. Thus, a player of the system operates the gaming device, typically a video slots game, whilst simultaneously participating at karaoke. A successful outcome on the karaoke device, as determined by any of the parameters mentioned above, freezes the reels in the slots game in a winning combination. It will be appreciated that typically slots games have a plurality of winning combinations, rewards for which range from low to high in relation to the probability of achieving the particular combination. Thus, the degree of success in performing on the karaoke facility will determine the combination of reels in the slots game.

The invention is not restricted to the slots game environment and a yet further application of the invention is to the game of Bingo. Once again, the achieving of a successful outcome in the primary Bingo game permits the successful participant access to the karaoke facility and, in order to win at the Bingo game, instead of typically having to shout “Bingo”, the successful participant has to sing a song on the karaoke facility.

In a further application of the invention, the gaming facility and karaoke facility are simply operable to enable a player on the system to participate simultaneously on both features of the system, without the outcomes on either of the devices being linked to access to, or an outcome of, the other of the facilities. Again, this aspect of the invention finds application mainly, but not exclusively, in a slots gaming environment. For example, this embodiment of the invention may also be applied to a Pachinko machine with screens.

Accordingly, the invention extends to a slots gaming system incorporating a karaoke facility to enable the simultaneous participation by a player in a slots game and in karaoke.

### BRIEF DESCRIPTION OF THE DRAWINGS

The invention will be described, by way of example only, with reference to the drawings in which:

FIG. 1 is a schematic view of a gaming system in accordance with a first embodiment of the invention;

FIG. 2 is a schematic view of a gaming system in accordance with a second embodiment of the invention;

FIG. 3 is a flow diagram of the steps of the method of the invention in a preferred embodiment thereof; and

FIG. 4 is a schematic view of the gaming system in accordance with a variation of the first embodiment of the invention.

### DETAILED DESCRIPTION OF THE DRAWINGS

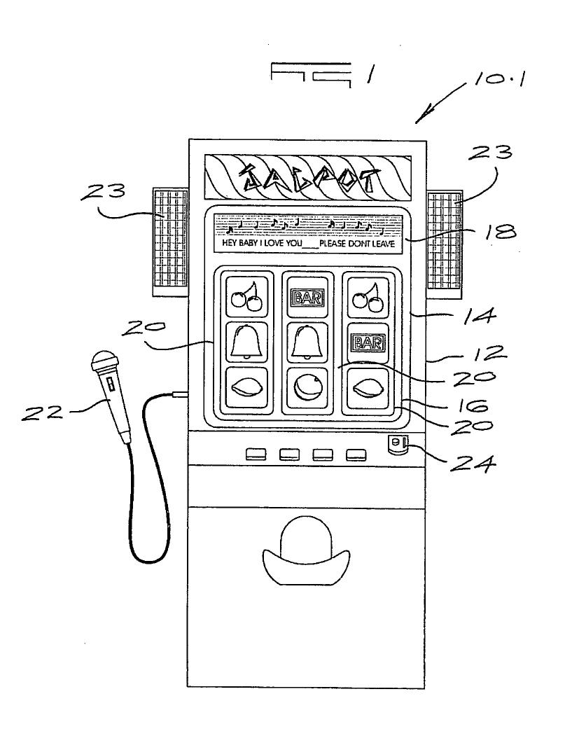

In the drawings, reference numeral 10 generally indicates a gaming system in accordance with an aspect of the invention. In FIG. 1, the gaming system 10.1 comprises a typical video slot machine 12, which has been adapted to incorporate a karaoke facility.

The slot machine 12 has a VDU 14, which is segmented under software control into two regions 16,18, a first of which 16 displays images of three reels 20 of a traditional slot machine and a second of which 18 displays images related to the karaoke facility. The slot machine 12 has a handheld microphone 22 and loudspeakers 23. The operation of the video slot machine 12 and the karaoke facility are under the control of a processor (not shown) functioning under software control. In the embodiment of the gaming system illustrated in FIG. 1, the video slot 12 machine has a slot 24 for receiving coins or tokens. It will, however, be appreciated that this feature is not restrictive and the video slot machine 12 may be of the type that accepts banknotes or the input of coded credit information via a keypad, or a card reader for reading credit cards or credit card-type tokens and the like.

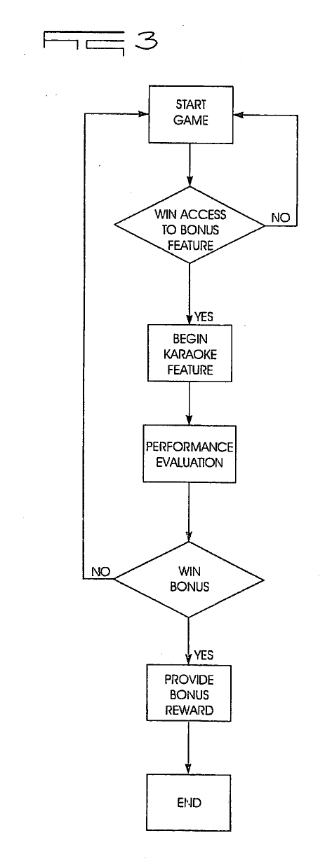

In use, the player using the slot machine 12 operates the machine in a coventional manner. The steps for operation of the system are set out in FIG. 3 of the drawings. The player purchases credit for the game, applies this credit to the slot machine 12 by inserting a token or tokens and starts the video slot game. The player proceeds with successive turns at the game until a successful outcome is achieved or until the player's credit is exhausted or the player wishes to terminate the game. Each unsuccessful outcome returns the player to the start of the game, enabling the player to participate in a further turn of the game if so desired and should sufficient in order to do so be available to the player. If, however, a successful outcome is achieved, the player is permitted to access the karaoke facility. It will be appreciated that a plurality of successful outcomes is available in most typical video slot machines. Thus, each successful outcome on the video slot game may have a corresponding one of a plurality of possible outcomes permitted on the karaoke facility. For example, a lowly-rated but successful outcome of the video slot game may permit access to the karaoke facility for the singing of only a single verse of a song on the karaoke facility, whereas a highly-rated successful outcome on the slot game may permit access to the karaoke facility to sing an entire song. Once access to the karaoke facility is granted, the karaoke portion 18 of the VDU 14 is utilized to display a graphic with lyrics of the song scrolling across the screen from right to left, while corresponding musical accompaniment is played through the loudspeakers 23 so as to be audible to the player at the slot machine 12. The player can then use the microphone to sing the scrolling lyrics in time to the musical accompaniment. Further, the graphic with scrolling lyrics may contain, as a background to the scrolling lyrics, a music video of the particular song being played. It will also be appreciated that instead of a handheld microphone 22, the slot machine 12 may have a built-in microphone, thereby facilitating hands-free operation of the karaoke facility.

The controller of the slot machine 12 incorporates sound analysis and comparison software and/or hardware to permit the analysis of sound input received via the microphone 22 and a comparison with saved reference data relating to the particular song being played by the karaoke facility. The software and/or hardware enables the input sound of the player's singing to be assessed and evaluated according to a number of criteria, including the correctness of the lyrics sung and the harmonic match between the input and the reference data. In addition, the amplitude of the input sound is evaluated and scored on a weighted scale. The scores for these parameters are combined to create a composite score. If the composite score is greater than a predetermined number, the player is awarded a bonus in the form a credit for play on the video slots game. It will be appreciated that many other characteristics related to the artistic performance of the player on the karaoke machine may be evaluated and scored. Instead of the award of a bonus, the player may be permitted to sing for a longer period of time. Further, instead of attempting to determine a quantitative score for the artistic performance of the player on the karaoke machine, the bonus may be awarded randomly. Once the award of a bonus on the karaoke facility is complete, the player is returned to the video slot game to resume play once more. If the player does not receive a bonus award via the karaoke facility, the player is returned to the video slot game and may resume play of the game.

The various components of the karaoke song, namely the lyrics, musical accompaniment and background video may be stored in non-volatile memory associated with the processor (not shown) of the slot machine 12. In this instance the karaoke facility will always display the same lyrics to the player and play the same musical accompaniment whenever the slot game permits access to the karaoke facility. In order to enhance the appeal of the gaming system 10.1, the non-volatile memory may store the lyrics, musical accompaniments and background videos of a number of different songs. In this instance, whenever the player obtains access to the karaoke facility, a randomly selected one of the number of different karaoke songs is made available to the player. Alternatively, the player is permitted to select one of the number of different karaoke songs from a menu.

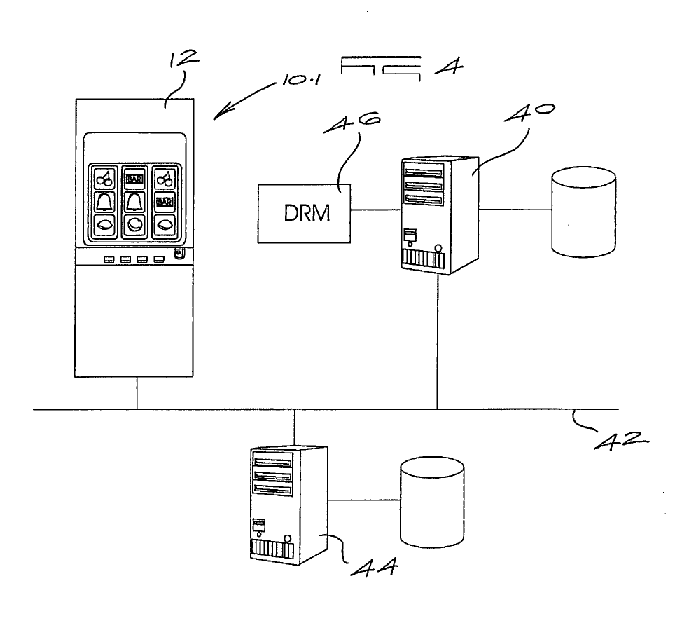

In a variation of the embodiment of FIG. 1, the slot machine 12 may be connected to a music server 40 containing a library of karaoke songs by means of a communication network 42 such as a local area network, wide area network or the Internet, as illustrated in FIG. 4. The processor (not shown) of the slot machine 12 may initiate an upload of new karaoke songs from the library of the music server 40 to the non-volatile memory from time to time or, alternatively, the music server 40 may periodically initiate a push of new karaoke songs from the library to the gaming machine 12. In this manner, the karaoke content of the gaming machine 12 can be updated from time to time and rendered fresh and exciting. In a similar manner, the gaming machine 12 may be connected by means of the communication network 42 to a game server 44 containing a library of games, which can be video slot games or other video games such as poker games, table games such as roulette, blackjack and the like. New video games may be downloaded periodically from the game server 44 to the gaming machine 12 or pushed from the game server to the gaming machine, thereby ensuring that the gaming machine regularly offers fresh game content, as well as fresh karaoke content, to the player. The music server 40 and the game server 44 may be separate servers of content or may be combined together as a single content server on the same hardware.

The music server 40 includes a digital rights management (“DRM”) facility 46 in the form of a software application that monitors and logs usage of the various karaoke songs in the library. More particularly, the gaming machine 12 transmits the following data set to the music server 40 whenever a player obtains access to the karaoke facility of the gaming machine: a code identifying a karaoke song that is made available to the player in the bonus game, a time and date at which the karaoke song commences playing, and a time and date at which the karaoke song stops playing. The DRM facility 46 in the music server 40 receives the data set from the gaming machine 12 and uses it to determine any royalties that may be due to publishers and performers of the various components of the karaoke songs from the library that have been used. The DRM facility may then compile periodic consolidated reports of various royalty payments that need to be made.

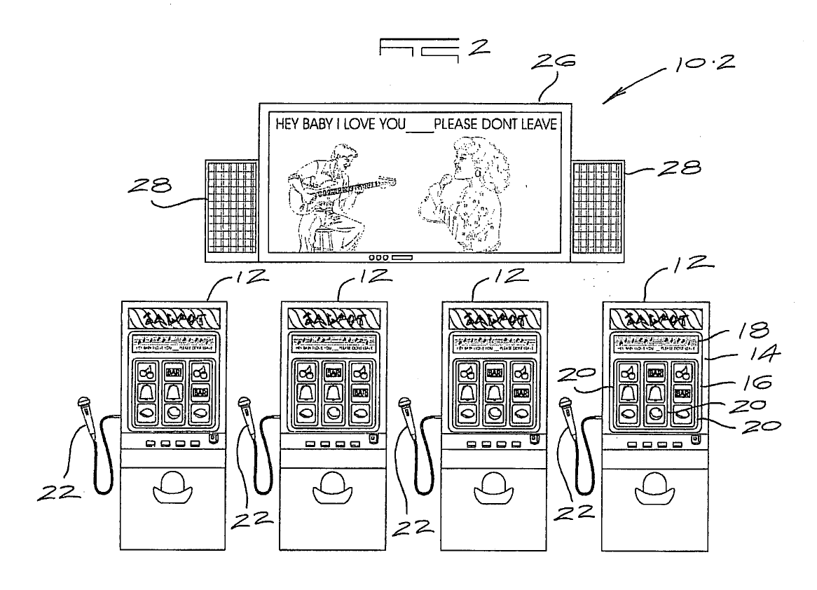

In FIG. 2, a further embodiment 10.2 of the gaming system is illustrated. In this embodiment, a bank of video slot machines 12 are networked to one another and a large LCD screen 26 and speakers 28 are positioned to be visible to players playing at each of the video slot machines 12. The video slot machines themselves are similar to those described above in respect of the embodiment of FIG. 1. In the second embodiment, the karaoke display of lyrics and accompanying music video is displayed on the LCD screen 26 located in the proximity of the bank of slot machines 12, and the performance of a winning player at any one of the slots machines 12 is broadcast so as to be audible within a region surrounding the bank of slot machines 12 and the LCD screen 26. This arrangement has the advantage of encouraging public participation at the bank of slot machines 12 and players may experience the satisfaction of being cheered on by an audience. In addition, the audience may be encouraged to show their appreciation for a performance on the karaoke facility by applauding, the amplitude of the applause being measured and used as a means for assessing whether the player singing at the karaoke facility receives an award or not.

As in the embodiment 10.1 of FIG. 1, each video slot machine 12 is connected to the music server 40 and, optionally, to the game server 44 by means of the communication network 42. As described above with reference to the embodiment of FIG. 1, fresh karaoke content contained in the library of karaoke songs in the music server 40 may be pushed or pulled between the music server and any of the slot machines 12. Similarly, fresh game content contained in a library of games in the game server 44 may be pushed or pulled between the game server and any of the video slot machines 12. The music server 40 and the game server 44 may be separate servers of content or may be combined together as a single content server on the same hardware.

It will be appreciated that many other versions of the invention may be implemented without departing from the spirit and scope of the invention. In particular, the coupling of a karaoke facility with a gaming facility may not be limited to video slot games but may be implemented with many other varieties of gaming, both land-based and online. Further, the karaoke facility may be used as a means for controlling the operation of the primary game, so that the attainment of a particular level of performance on the karaoke facility may be used, in the example of a video slot game, to stop the slot reels at a winning combination. In other words, the player's performance on the karaoke facility (the bonus game) determines the chance of the player winning a prize in the primary game. Still further, the karaoke facility may be combined and incorporated with a slot machine to enable the simultaneous use of the gaming facility and karaoke facility independently, without necessarily having them interact with one another. Yet further, in the embodiment 10.2 of FIG. 2, a plurality of players at different corresponding gaming machines 12 in the bank of machines may simultaneously utilize the karaoke facility to compete against each other for a jackpot prize, possibly a progressive prize, in which each player's performance is evaluated and scored. As an alternatively, the plurality of players at the different corresponding gaming machines 12 in the bank of machines may compete against each other for the right to play the video slots game to compete for a jackpot prize, which could be a conventional progressive jackpot prize.

Additionally, the video slot machine 12 may incorporate a feature whereby a player who has obtained a successful outcome in the video slot game and has consequently won a prize in the form of credit for play, may gamble (i.e. put at risk) such prize. The player gambles the prize by utilizing the karaoke facility to sing a portion of a particular song. The player's performance is evaluated and scored, resulting either in a forfeit of the prize if the performance is unsatisfactory or an increased prize if the performance exceeds a desired threshold. As an alternative, the outcome of the gamble may be decided randomly.

The karaoke facility may also interact with the gaming facility in such a manner that satisfactory performance of the player on the karaoke facility results in a bonus award of a number of turns of the slot game that do not consume the player's credit in order to play (i.e. “free spins”). The number of free spins that are awarded to the player as a bonus is proportional to the quality of the player's singing performance. During the free spins, the player may win prizes that consist either of credit, or extended use of the karaoke facility.

Instead of only displaying a graphic with lyrics of a song scrolling across the screen 18, 26 of the gaming system 10.1 or 10.2, the karaoke facility may display original video footage of a song from a film or stage musical. While the video footage, which is drawn from a video library, is displayed, the player is required to sing the words of the song in accompaniment to the video. Additionally, the karaoke facility may also require the player to recite dialogue from video footage from a play or a film, rather than sing.

The player may also exchange credit for play in order to purchase a digital recording of the player's performance on the karaoke facility. The player's performance may be transferred from the karaoke facility to a flash memory device connectable to the gaming server.

The invention thus capitalizes on the growing demand for ‘Bonus Feature’ gambling games and permits a player of a video slot game, for example, to interact vocally in order to win either more money, or a reward (the opportunity to sing through karaoke), or another award of a prize.

1. A gaming system, including:
a pair of interactive devices, a first of which being a gaming machine for playing a game of chance and a second of which being a karaoke machine; and
at least one of the interactive devices being operable to permit a user of the device to achieve any one of a plurality of outcomes on a turn at the device and the interactive devices being co-operable so that the achievement of a predetermined one of the plurality of outcomes on the said at least one interactive device enables the user to access the other of the interactive devices and to participate thereon
characterized in that
at least one of the interactive devices is communicable with a content server capable of providing different game or karaoke content for the said at least one interactive device.

2. A system as claimed in claim 1 in which both interactive devices are communicable with the content server, said content server being capable of providing different game and karaoke content for the interactive devices.

3. A system as claimed in claim 2 in which the content server includes a digital rights management facility operable to monitor and log the usage of karaoke songs on the second interactive device.

4. A system as claimed in claim 3 in which the plurality of outcomes on the at least one of the devices may include at least one successful outcome and one or more unsuccessful outcomes, each successful outcome having a corresponding degree of success and entitling a user of the interactive device to an award, the value and size of the award being related to the degree of success of the outcome.

5. A system as claimed in claim 4 in which the award for a successful outcome is access to the other one of the interactive devices.

6. A system as claimed in claim 5 in which the gaming machine is a land-based gaming machine or a plurality of linked land-based gaming machines.

7. A system as claimed in claim 6 in which the karaoke machine includes a display monitor, a microphone, an amplification means, at least one speaker, sound analysis means for evaluating the user's karaoke performance, and at least one external sound sensor for measuring ambient sounds.

8. A system as claimed in claim 7 in which the sound analysis evaluates the user's karaoke performance as a function of any one or more of the amplitude, tone, pitch, pace, style, intonation, pronunciation, accuracy, musicality and effort of the performance.

9. A system as claimed in claim 1 in which the pair of interactive devices are co-operable to also enable the user to access both of the devices simultaneously, without the outcomes on either of the devices being linked to access to, or an outcome of, the other interactive device.

10. A method of operation of a gaming system comprising the steps of:
providing a pair of interactive devices, a first of which being a gaming machine for playing a game of chance and a second of which being a karaoke machine; and
operating at least one of the interactive devices to permit a user of the device to achieve any one of a plurality of outcomes on a turn at the device; and
enabling co-operation between the interactive devices so that the achievement of a predetermined one of the plurality of outcomes on the said at least one interactive device enables the user to access the other of the interactive devices and to participate thereon
characterized in that
the method includes the further step of providing communication between at least one interactive device and a content server to obtain different game or karaoke content for the said at least one interactive device from time to time.

11. A method as claimed in claim 10 in which communication is provided between both interactive devices and a content server to obtain different game and karaoke content for the interactive devices.

12. A method as claimed in claim 11 which includes a step of monitoring and logging the usage of karaoke songs on the second interactive device.

13. A method as claimed in claim 12 in which at least one successful outcome and one or more unsuccessful outcomes are included in the plurality of outcomes on the at least one of the devices, each successful outcome having a corresponding degree of success and entitling the user of the interactive device to an award, the value and size of the award being related to the degree of success of the outcome.

14. A method as claimed in claim 13 in which access to the other of the interactive devices is provided as the award for a successful outcome.

15. A method as claimed in claim 14 in which one or more linked land-based gaming machines are used as the gaming machine

16. A method as claimed in claim 15 in which the user's karaoke performance is evaluated as a function of any one or more of the amplitude, tone, pitch, pace style intonation, pronunciation accuracy, musicality and effort of the performance.

17. A method as claimed in claim 10 in which the pair of interactive devices are operable to also enable the user to access both of the devices simultaneously, without the outcomes on either of the devices being linked to access to, or an outcome of, the other interactive device.
